(19) United States
(12) Patent Application Publication
(10) Pub. No.: US 2011/0010198 A1
(43) Pub. Date: Jan. 13, 2011

(54) SYSTEM AND METHOD FOR REMOTE HEALTH MANAGEMENT

(76) Inventors: Jaime Borras, Miramar, FL (US); Don Rosen, Staten Island, NY (US); Jeffrey A. Wolf, Miami Beach, FL (US)

Correspondence Address: Donald D. Mondul;Law Office of Donald D. Mondul, PO Box 1203, Seeley Lake, MT, 59868-1203, US

(21) Appl. No.: 12/833,286

(22) Filed: Jul. 9, 2010

Related U.S. Application Data
(63) Continuation of application No. 12/557,238, filed on Sep. 10, 2009.
(60) Provisional application No. 61/224,624, filed on Jul. 10, 2009.

(51) Int. Cl. G06Q 50/00

(52) U.S. Cl. 705/3; 705/2

(57) ABSTRACT

A system for remote care management includes: (a) a communicating management unit coupled with at least one care rendering unit; the communicating management unit includes a principal decision support unit; and (b) at least one remote unit communicatingly coupled with the communicating management unit. The at least one remote unit includes at least one disconnected mode capable remote unit. The at least one disconnected mode capable remote unit includes an ancillary decision support unit. At least one of the principal decision support unit and the ancillary decision support unit cooperates with the communicating management unit to present at least one recommended result based upon at least one predetermined set of parametric values to effect remote health management.

This application claims benefit of prior filed copending Provisional Patent Application Ser. No. 61/224,624, filed Jul. 10, 2009.

This application is a continuation of and claims priority to, and incorporates by reference, U.S. patent application Ser. No. 12/557,238, filed Sep. 10, 2009.

### FIELD OF THE INVENTION

The present invention is directed to managed health care, and especially to mobile collaborative remotely managed health care having a reduced operational requirement for inter-unit communications.

### BACKGROUND OF THE INVENTION

Health care providers and others have long known that preventive health care can reduce costs and improve effectiveness of care. However, arranging for sufficiently close monitoring of patients by health care providers has heretofore been expensive, even prohibitively expensive for widespread implementation of a sufficiently closely monitored health care monitoring system.

Developments in communication technology have improved conveyance of test results from patients to health care providers. Developments in testing methods have provided more reliable, more timely and more objectively measurable test results. Developments in diagnostic capabilities have improved accuracy and timeliness of evaluation of test results to diagnose treatment.

It would be advantageous to reduce the amount of communication required to carry out operation of such a remote health management system in the interest of reducing traffic load on communication links in such a remote health management system.

There is a need for a system and method for remote health management that advantageously employs communication, testing and diagnostic capabilities to advantageously effect preventive health care in a timely, cost-effective and efficient manner.

### SUMMARY OF THE INVENTION

A system for remote care management includes: (a) a communicating management unit coupled with at least one care rendering unit; the communicating management unit includes a principal decision support unit; and (b) at least one remote unit communicatingly coupled with the communicating management unit. The at least one remote unit includes at least one disconnected mode capable remote unit. The at least one disconnected mode capable remote unit includes an ancillary decision support unit. At least one of the principal decision support unit and the ancillary decision support unit cooperates with the communicating management unit to present at least one recommended result based upon at least one predetermined set of parametric values to effect remote health management.

A method for remote care management includes: (a) in no particular order: (1) providing a communicating management unit coupled with at least one care rendering unit; (2) providing a principal decision support unit coupled with the communicating management unit; (3) providing at least one remote unit coupled with the communicating management unit; the at least one remote unit including at least one disconnected mode capable remote unit; and (4) providing an ancillary decision support unit coupled with the at least one disconnected mode capable remote unit; and (b) operating at least one of the principal decision support unit and the ancillary decision support unit cooperatively with the communicating management unit to present at least one recommended result based upon at least one predetermined set of parametric values to effect remote health management.

It is, therefore, a feature of the present invention to provide a system and method for remote health management that advantageously employs communication, testing and diagnostic capabilities to advantageously effect preventive health care in a timely, cost-effective and efficient manner.

Further features of the present invention will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

FIG. 1 is a schematic diagram illustrating the system of the present invention.

FIG. 2 is a schematic diagram illustrating details of the application server employed in the system of the present invention.

FIG. 3 is a schematic diagram illustrating how a user may interact with the system of the present invention.

FIG. 4 is a schematic diagram illustrating details of the base station illustrated in FIG. 3.

FIG. 5 is a top plan view of a representative mobile unit for use with the present invention.

FIG. 6 is a side view of the representative mobile unit illustrated in FIG. 5.

FIG. 7 is a flow chart illustrating the method of the present invention.

FIG. 8 is a schematic diagram illustrating an improved remote health management system.

FIG. 9 is a top-level schematic diagram of the system illustrated in FIG. 1.

FIG. 10 is a top-level schematic diagram of the system illustrated in FIG. 8.

FIG. 11 is a flow chart illustrating the method for improved remote health management of the present invention.

### DETAILED DESCRIPTION OF THE PREFERRED EMBODIMENT

The terms “coupled” and “connected”, along with their derivatives, may be used herein. It should be understood that these terms are not intended as synonyms for each other. Rather, in particular embodiments, “connected” may be used to indicate that two or more elements are in direct physical or electrical contact with each other. “Coupled” may be used to indicated that two or more elements are in either direct or indirect (with other intervening elements between them) physical or electrical contact with each other, or that the two or more elements co-operate or interact with each other (e.g. as in a cause and effect relationship).

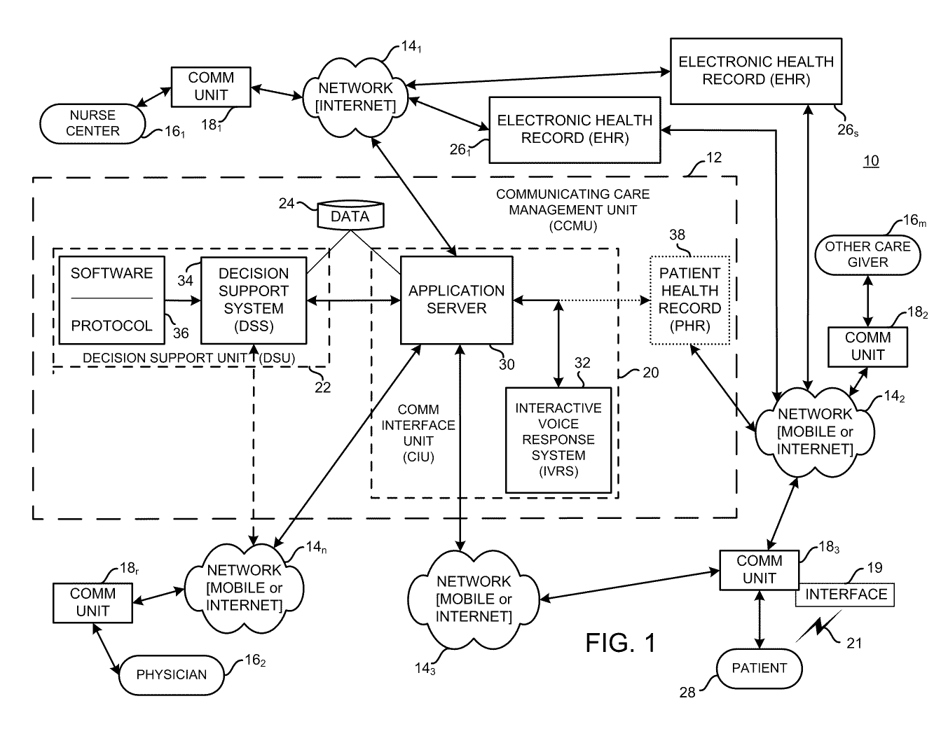

FIG. 1 is a schematic diagram illustrating the system of the present invention. In FIG. 1, a remote health management system 10 configured for effecting mobile collaborative health care with a plurality of patients includes a communicating care management unit 12 and at least one communication network 14₁, 14₂, 14₃, 14ₙ. The indicator “n” is employed to signify that there can be any number of communication networks in remote health management system 10. The inclusion of four communication centers control centers 14₁, 14₂, 14₃, 14ₙ in FIG. 1 is illustrative only and does not constitute any limitation regarding the number of communication networks that may be included in the remote health management system of the present invention. By way of example and not by way of limitation, each respective communication network 14ₙ may be embodied in a private data network, a mobile communication network or another network, such as the Internet. Throughout this description, use of a reference numeral using a generic subscript herein may be taken to mean that any respective member of the plurality of elements having the same reference numeral may be regarded as included in the description. Thus, by way of example and not by way of limitation, referring to communication centers control center 14ₙ in describing FIG. 1 may be taken to mean that any communication centers control center—14₁, 14₂, 14₃, or 14ₙ (FIG. 1)—may be regarded as capable of employment as described.

Remote health management system 10 may also include at least one care rendering unit 16₁, 16₂, 16ₘ. The indicator “m” is employed to signify that there can be any number of care rendering units in remote health management system 10. The inclusion of three care rendering units 16₁, 16₂, 16ₘ in FIG. 1 is illustrative only and does not constitute any limitation regarding the number of care rendering units that may be included in the remote health management system of the present invention. By way of example and not by way of limitation, a respective care rendering unit 16ₘ may be embodied in a nurse center (e.g., care rendering unit 16₁), a physician (e.g., care rendering unit 16₂) or another care giver (e.g., care giving unit 16ₘ). Other care givers may include, by way of example and not by way of limitation, hospice facilities and weight loss clinics.

Remote health management system 10 may further include a plurality of remote communicating units 18₁, 18₂, 18₃, 18ᵣ. The indicator “r” is employed to signify that there can be any number of remote communicating units in remote health management system 10. The inclusion of four remote communicating units 18₁, 18₂, 18₃, 18ᵣ in FIG. 1 is illustrative only and does not constitute any limitation regarding the number of remote communicating units that may be included in the remote health management system of the present invention. By way of example and not by way of limitation, each respective communicating unit 18ᵣ may be embodied in a mobile phone or other wireless device, a computer network interface, or another communicating unit for effecting digital communications between a user and communicating care management unit 12.

Communicating care management unit 12 may include a communication interface unit 20 coupled with a decision support unit 22. Communication interface unit 20 and decision support unit 22 may share a data store 24.

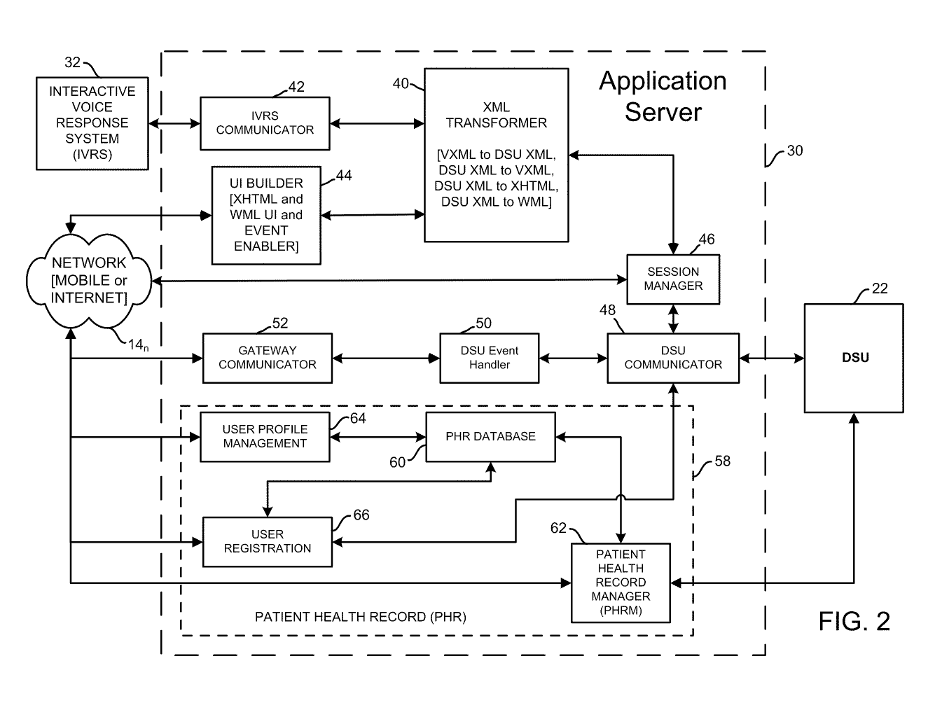

Communication interface unit 20 may include an application server 30 (described in greater detail in connection with FIG. 2) for managing communication operations, and a coupled interactive voice response system 32. Decision support unit 22 may include a decision support system 34 supported by a coupled software program or protocol 36.

Communicating care management unit 12 may further include a patient health record 38 for storing patient health information on-line in a digital format.

Selected communication networks 14ₙ may be coupled for sharing information with other on-line electronic health record systems 26₁, 26ₛ. The indicator “s” is employed to signify that there can be any number of on-line electronic health record systems in remote health management system 10. The inclusion of two on-line electronic health record systems 26₁, 26ₛ in FIG. 1 is illustrative only and does not constitute any limitation regarding the number of on-line electronic health record systems that may be included in the remote health management system of the present invention. Examples of on-line health record systems may include, by way of example and not by way of limitation, Google Health® and Microsoft Healthvault®.

Remote health management system 10 permits a user to employ a remote communicating unit 18ᵣ and a communication network 14ₙ to establish communications with communicating care management unit 12 to effect remote health management such as, by way of example and not by way of limitation, mobile collaborative health care. A user may be a care rendering unit 16ₘ or a patient 28. In such a remote health management system 10 a patient 28 or care rendering unit 16ₘ may convey test results, such as a blood sugar reading from a blood sugar measuring device, via a remote communicating unit 18ᵣ (such as a mobile phone unit) and a communication network 14ₙ (such as a mobile network) to communication management care unit 12 via application server 30 or decision support system 34. By way of example and not by way of limitation, patient 28 may wirelessly communicate (indicated at 21 in FIG. 1) with remote communicating unit 18₃ via an interface unit 19 to effect the desired connection with remote health management system 10. Interface unit 19 may be configured to provide specialized wireless connections directly with patient monitoring devices (not shown in detail in FIG. 1) such as, by way of example and not by way of limitation, blood testing, glucose testing, blood pressure testing, weight measuring or other testing or measuring apparatuses. Specialized wireless connections may include, by way of further example and not by way of limitation, Bluetooth wireless connections. The diagnostic information (i.e., blood sugar reading) may be evaluated using software or protocol 36 in cooperation with decision support system 34 and a recommendation may be provided to the patient via the mobile network and mobile communication unit either directly by decision support system 34 or in cooperation with application server 30. The recommendation may be in response to a voice reporting of the blood sugar reading (or other information) conveyed in a voice message generated by interactive voice response system 32 in cooperation with application server 30. An interactive voice response system may be an automated telephone information system that speaks to a caller with a combination of fixed voice menus and data extracted from databases, such as patient health record 38. Blood sugar readings (or other information) may be conveyed by a patient 28 or care rendering unit 16ₘ via a cable hookup to interface unit 19 at the sender's location. Alternatively, as mentioned earlier herein, information may be conveyed to interface unit 19 at the sender's location via a wireless connection 21 such as, by way of example and not by way of limitation, a Bluetooth link.

Information may originate from a care rendering unit 16ₘ to remind patient 28 to take prescribed medication, to inquire whether patient 28 has made a particular appointment or to inquire as to another aspect of patient 28 health or other circumstances.

Test results or recommendations may be entered into patient health record 38. Information stored in patient health record 38 may be used by application server 30 or decision support unit 22 in formulating later inquiries to patient 28 regarding prescribed actions originating from a care rendering unit 16ₘ. Such two-way communication and such two-way use of information—for reporting and for managing health of a patient—among care rendering units 16ₘ and patient 28 in cooperation with communicating care management unit 12 establishes a mobile collaborative health care system having significant value in affording preventive health care for patient 28. Patient health record 38 may participate in such collaborative health care, and electronic health records 26ₛ may as well be included in such a system.

FIG. 2 is a schematic diagram illustrating details of the application server employed in the system of the present invention. In FIG. 2, application server 30 is illustrated as coupled with a decision support unit (DSU) 22, an interactive voice response system (IVRS) 32 and a communication network 14ₙ, generally as described in connection with FIG. 1.

Application 30 may include a translation unit 40 embodied, by way of example and not by way of limitation in an XML transformer unit. Translation unit 40 effects translation among a variety of information or communication formats that may be conveyed within remote health management system 10 (FIG. 1). By way of further example and not by way of limitation, translation unit 40 may effect translation among the following information or communication formats:

XML (eXtensible Markup Language)—a formal recommendation from the World Wide Web Consortium (W3C). It is a flexible, human readable way of describing structured data. XML is a way to create common information formats and share both the format and the data on the World Wide Web, intranets and elsewhere. XML can be used by any individual or group of individuals or companies that wants to share information in a consistent way. XML is similar to the Hypertext Markup Language (HTML). Both XML and HTML contain markup symbols to describe the contents of a page or file. HTML, however, describes the content of a Web page (mainly text and graphic images) only in terms of how it is to be displayed and interacted with. XML describes the content in terms of what data is being described. XML is “extensible” because, unlike HTML, the markup symbols are unlimited and self-defining.

VXML (Voice Extensible Markup Language, or VoiceXML)—a technology that allows a user to interact with the Internet or another network through voice-recognition technology. Instead of a traditional browser that relies on a combination of HTML and keyboard and mouse, VXML relies on a voice browser or a telephone. Using VXML, a user may interact with a voice browser by listening to an audio output that is either pre-recorded or computer-synthesized and submitting an audio input through the user's natural speaking voice or through a keypad, such as a telephone.

XHTML (Extensible Hypertext Markup Language)—a reformulation of HTML 4.0 as an application of the eXtensible Markup Language (XML). The term extensible indicates that the markup language can be used to invent a particular set of markup symbols for a particular purpose. The result is XHTML may be used as an application of XML for “expressing” Web pages.

WML (Wireless Markup Language)—based on XML, WML is a content format for devices that implement the Wireless Application Protocol (WAP) specification, such as mobile phones. WML preceded the use of other markup languages now used with WAP, such as XHTML. WML documents are XML documents that validate against the WML DTD (Document Type Definition).

Translation unit 40 may be coupled with an IVRS communicator unit 42 to aid in effecting communications with IVRS 32. Translation unit 40 may be coupled with communication network 14ₙ via a user interface (UI) builder unit 44 to aid in effecting communications with communication network 14ₙ. UI Builder unit 44 may aid translation unit 40 in carrying out some translation operations.

Translation unit 40 may also be coupled with a session manager unit 46. Session manager unit 46 may be configured to manage session scheduling for events addressed by translation unit 40 or IVRS 32. Session manager unit 46 may be coupled with communication network 14ₙ to aid scheduling access among communication network 14ₙ, translation unit 40 and IVRS 32. Session manager unit 46 may be coupled with decision support unit (DSU) 22 via a DSU communicator unit 48 to aid scheduling access among DSU 22, translation unit 40 and IVRS 32.

DSU communicator unit 48 may also be coupled with communication network 14n via a DSU event handler unit 50 and a gateway communicator unit 52 to manage communications by DSU 22 with other entities in remote health management system 10 (FIG. 1) such as, by way of example and not by way of limitation, care rendering units 16ₘ and patient 28.

The embodiment of application server 30 illustrated in FIG. 2 includes an integral patient health record 58 contained within application server 30 in contrast with a separately configured and coupled patient health record 38, as illustrated in FIG. 1. Integral patient health record 58 includes a patient health record data base unit 60 for storing information relating to patient health records. Patient health record data base unit 60 is coupled with DSU 22 via a patient health record manager unit 62 to coordinate inputs to patient health record data base unit 60 from DSU 22. Patient health record data base unit 60 is also coupled with communication network 14ₙ via patient health record manager unit 62 to coordinate inputs to patient health record data base unit 60 from communication network 14ₙ. Patient health record data base unit 60 is coupled with communication network 14ₙ via a user profile management unit 64 to aid in communicating with users (e.g., care rendering units 16ₘ or patient 28) via communication network 14ₙ. A user registration unit 66 is coupled among communication network 14ₙ, patient health record data base unit 60 and DSU communicator unit 48 to effect registration of a user appropriately so as to provide data entries identified with respect to the user after registration for use within remote health management system 10 (FIG. 1).

Throughout this description, use of a reference numeral using a generic subscript herein may be taken to mean that any respective member of the plurality of elements having the same reference numeral may be regarded as included in the description. Thus, by way of example and not by way of limitation, referring to communication network 14ₙ in describing FIG. 2 may be taken to mean that any communication network—14₁, 14₂, 14₃, or 14ₙ (FIG. 1)—may be regarded as capable of employment as described.

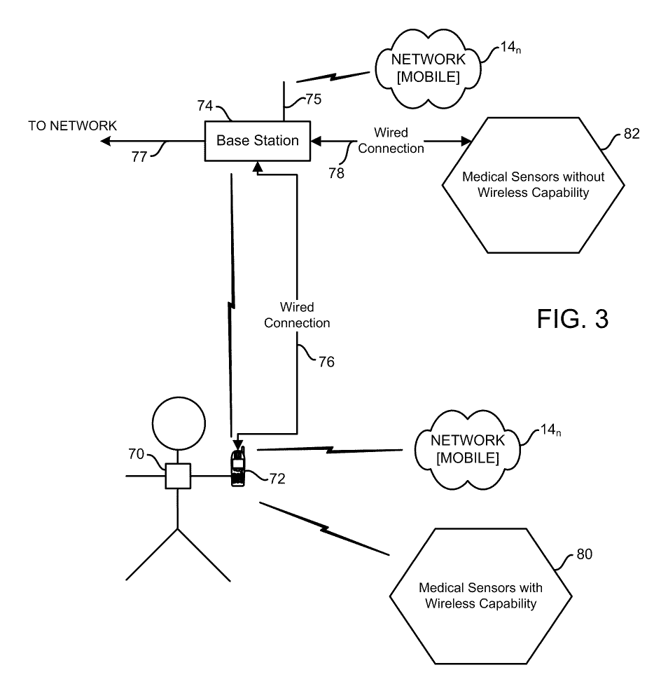

FIG. 3 is a schematic diagram illustrating how a user may interact with the system of the present invention. In FIG. 3, a user 70 may communicate with a network 14n using a mobile phone unit 72. Mobile phone unit 72 may be linked wirelessly with a base station 74. Alternately mobile phone unit 72 may be embodied in a cordless phone unit (not separately indicated in FIG. 3) having a lesser effective communicating range than a mobile phone unit such as a cellular phone, but still wirelessly coupled with base station 74.

Yet another embodiment provides a wired link or connection 76 between mobile phone unit 72 and base station 74. In a preferred embodiment, mobile phone unit 72 carries on all communications between user 70 and remote health management system 10 (FIG. 1). Medical sensors 80 having a wireless linking capability may link wirelessly with mobile phone unit 72 for conveyance of information generated by medical sensors 80 to remote health management system 10 via communication network 14ₙ. Medical sensors 82 not having a wireless linking capability may be linked with base station 74 via a wired link or connection 78 for conveyance of information generated by medical sensors 82. Information thus obtained by base station 74 may be conveyed to mobile phone unit 72 wirelessly or via wired connection 76 for relay to remote health management system 10 via communication network 14ₙ.

Base station 74 may, in an alternate embodiment, have a capability for wireless linking with a communication network 14ₙ, or base station 74 may have a land line connection with another network 14ₙ (not shown in FIG. 3) such as the Internet.

In any of the alternate embodiments described above, base station 74 may include additional capabilities complementary to operation of remote health management system 10 (FIG. 1). Base station 74 may provide an intelligent charging function for a mobile phone unit 77, providing intelligent indications of charging status such as via light indicators or voice alerts. Base station 74 may provide other alert indicators—visual or audio—relating to events such as, by way of example and not by way of limitation, occasions for taking medication, occasions for calling one's physician, occasions for checking a medical condition such as blood sugar or blood pressure or another occasions. Base station 74 may be responsive to signals received from mobile phone unit 72 for effecting the alerting or other functioning of base station 74.

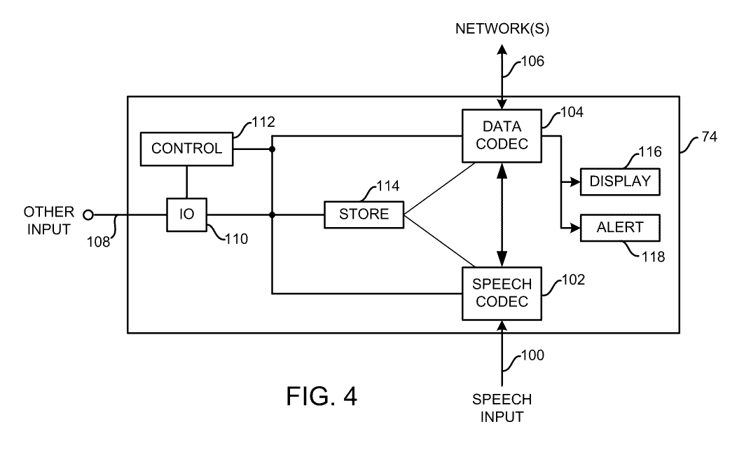

FIG. 4 is a schematic diagram illustrating details of the base station illustrated in FIG. 3. In FIG. 4, base station 74 may include a speech input locus 100 to a speech CODEC (Coder-Decoder) unit 102. Speech CODEC 102 converts speech received at speech input locus 102 to a digital representation of the received speech and provides that digital representation to a data CODEC 104. Data CODEC 104 treats the received digital signal as required to present an appropriately coded signal for transmission via a communication coupling 106 (e.g., a land line or a wireless connection) to a network (e.g., communication network 14ₙ; FIG. 1). Data CODEC 104 may employ information stored in a data store 114 in formulating the coded signal for transmission via coupling 106. Another input locus 108 receives other than speech signals (e.g., wireless signals or wired connection signals (see FIG. 3) to an input-output (IO) unit 110 and then to either data store 114 or data CODEC 104 as appropriate for proper operation of base station 74. A control unit 112 is coupled with speech CODEC 102, data CODEC 104, IO unit 110 and data store 114 to effect proper operation of base station 74.

Control unit 112, data store 114 and data CODEC 104 may cooperate to detect operation of visual or audio displays and alerts operating display unit 116 or alert unit 118 appropriately to effect proper operation of base station 74 in response to input signals received at speech input locus 100 or other input locus 108.

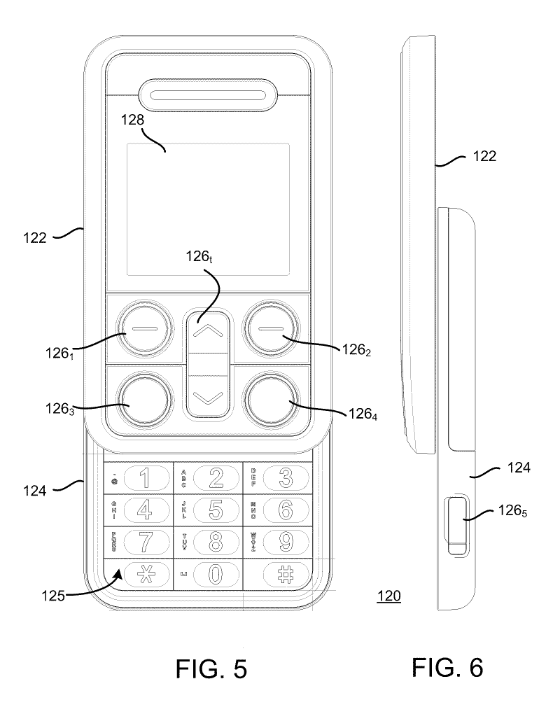

FIG. 5 is a top plan view of a representative mobile unit for use with the present invention. FIG. 6 is a side view of the representative mobile unit illustrated in FIG. 5. Regarding FIGS. 5 and 6 together, a mobile phone unit 120 includes a phone body 122 slidingly receiving a keypad unit 124. Phone body 122 and keypad unit 124 are coupled to effect cooperative operation in carrying out mobile communications. Phone body 122 and keypad unit 124 are illustrated in FIGS. 5 and 6 in an operational orientation with keypad unit 124 presenting a key matrix 125 exposed for access by a user for effecting data entry using key matrix 125. Keypad unit 124 may be slid into substantial register with phone body 122 to a stowed position presenting a more compact package and protecting keypad unit 124 in while in the stowed position. Mobile phone unit 120 has a plurality of actuators or buttons 126₁, 126₂, 126₃, 126₄, 126₅, 126ₜ. The indicator “t” is employed to signify that there can be any number of actuators or buttons in mobile phone unit 120. The inclusion of six actuators or buttons 126₁, 126₂, 126₃, 126₄, 126₅, 126ₜ in FIGS. 5 and 6 is illustrative only and does not constitute any limitation regarding the number of actuators or buttons that may be included in the mobile phone unit 120 of the present invention. Actuators 126ₜ may be employed by a user for navigate functions of mobile phone unit 120, including entry of medical information and retrieval of medical information such as, by way of example and not by way of limitation, reminders, alerts, queries and other information sent or received using mobile phone unit 120. Mobile phone unit 120 also includes a display unit 128 for effecting communications within remote health management system 10 (FIG. 1).

Mobile phone unit 120 may operate using a common carrier communication network 14ₙ, or may operate using a proprietary network independent of common carrier networks. Operators of remote health management systems of the sort disclosed herein may advantageously tailor service offerings that provide incentives such as, by way of example and not by way of limitation, free minutes, fee text messages and other mobile network consumer offerings. Such incentives may be provided as features of health plans, employers, or other organizations as a way to encourage adoption of a remote health management system to encourage consumer participation in disease management and wellness programs.

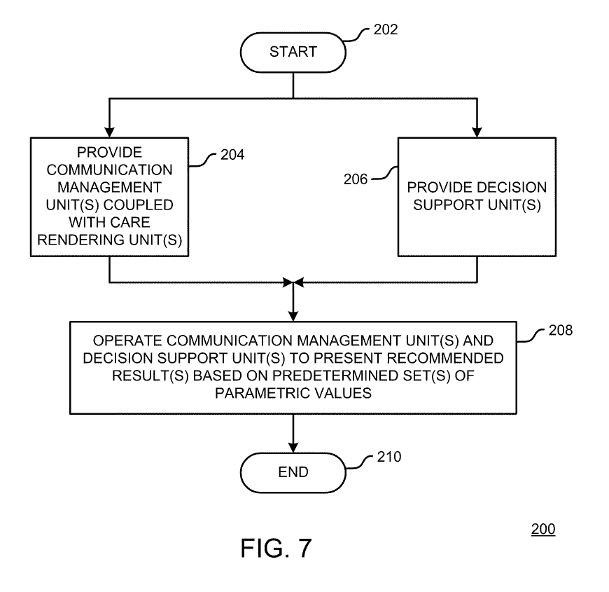

FIG. 7 is a flow chart illustrating the method of the present invention. In FIG. 7, a method 200 for remote health management begins at a START locus 202. Method 200 continues with, in no particular order: (1) providing a communicating management unit coupled with at least one communication network, at least one care rendering unit being coupled with the at least one communication network, as indicated by a block 204; and (2) providing a decision support unit coupled with at least one selected communication network of the at least one communication network, a plurality of remote communicating units being coupled with at least one selected care rendering entity of the at least one care rendering entity via the at least one communication network and at least one of the communicating management unit and the decision support unit, as indicated by a block 206. Method 200 continues with operating at least one of the communicating management unit and the decision support unit to participate in selected communications among the at least one selected care rendering entity and the plurality of remote communicating units to present at least one recommended result based upon at least one predetermined set of parametric values to effect the remote health management, as indicated by a block 208. Method 200 terminates at an END locus 210.

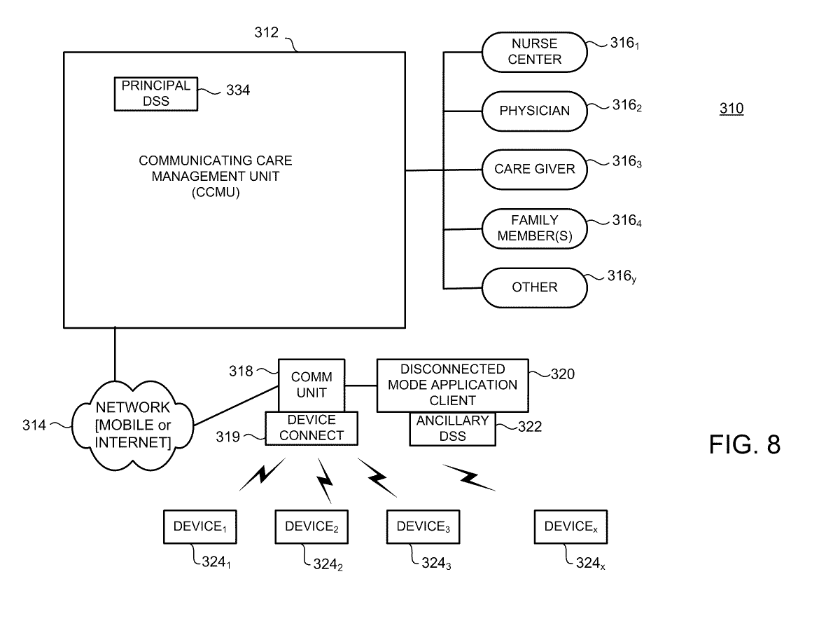

FIG. 8 is a schematic diagram illustrating an improved remote health management system. In FIG. 8, a remote health management system 310, configured for effecting mobile collaborative health care with a plurality of patients includes a communicating care management unit 312 and at least one communication network 314.

Remote health management system 310 may also include at least one care rendering unit 316₁, 316₂, 316₃, 316₄, 316_{y}. The indicator “y” is employed to signify that there can be any number of care rendering units in remote health management system 310. The inclusion of five care rendering units 316₁, 316₂, 316₃, 316₄, 316_{y} in FIG. 8 is illustrative only and does not constitute any limitation regarding the number of care rendering units that may be included in the remote health management system of the present invention. By way of example and not by way of limitation, a respective care rendering unit 316_{y} may be embodied in a nurse center (e.g., care rendering unit 316₁), a physician (e.g., care rendering unit 316₂), a care giver (e.g., care rendering unit 316₃), one or more family members (e.g., care rendering unit 316₄) or another care giver (e.g., care giving unit 16_{y}). Other care givers may include, by way of example and not by way of limitation, hospice facilities and weight loss clinics.

Remote health management system 310 may further include a plurality of remote communicating units (see FIG. 1) represented in FIG. 8 by a remote communicating unit 318. In remote health management system 310 communicating unit 318 is embodied in a disconnected mode capable remote unit capable of conducting some remote health care evolutions substantially independently of communicating care management unit 312. By way of example and not by way of limitation, each respective communicating unit 318 may be embodied in a mobile phone or other wireless device, a computer network interface, or another communicating unit for effecting digital communications between a user and communicating care management unit 312.

Communicating care management unit 312 may include components substantially as described in connection with FIG. 1 above, including a decision support system 334 (internal connections within communicating care management unit 312 are not shown in detail in FIG. 8; see FIG. 1 for details). In remote health management system 310, disconnected mode capable remote unit 318 includes an ancillary decision support system 322 associated with a disconnected mode application client unit 320 that oversees operation of ancillary decision support system 322 and other aspects of operation of communication unit 318 in connection with remote health management system 310. Disconnected mode application client 320 may be configured and operate similarly to application server 30 (see FIGS. 1 and 2).

Communication unit 318 may operate with disconnected mode application client 320 and ancillary decision support system 322 using data that is manually entered into communication unit 318. Alternatively, communication unit 318 may be configured with a device connect unit 319 such as, by way of example and not by way of limitation, a Bluetooth wireless interface. When such a wireless interface is available, communication unit 318, disconnected mode application client 320 and ancillary decision support system 322 may cooperate to effect automatic entry of data from a variety of health measuring devices 324₁, 324₂, 324₃, 324ₓ and automatic forwarding of data received from devices 324ₓ to a primary communicating care management unit such as communicating care management unit 312 and to selected caregivers 316_{y}. The indicator “y” is employed to signify that there can be any number of health measuring devices in remote health management system 310. The inclusion of four health measuring devices 324₁, 324₂, 324₃, 324ₓ in FIG. 8 is illustrative only and does not constitute any limitation regarding the number of health measuring devices that may be included in the remote health management system of the present invention.

FIG. 9 is a top-level schematic diagram of the system illustrated in FIG. 1. In FIG. 9, a remote health management system 410 includes a communicating care management unit 412 and at least one communication network 414. Communicating care management system 412 may include a decision support unit or system 434 and a patient health record database 438 as previously described herein. Communicating care management system 412 may communicate with network 414 via a gateway 433, as may be understood by one skilled in the art of communications. Communication unit 418 is illustrated in FIG. 9 as a wireless communication unit. However, the present invention may operate equally well with other communication units such as, by way of example and not by way of limitation, land line phone units, VoIP (Voice Over Internet Protocol) phone units, communicating computer units, smart phones, personal digital assistant (PDA) units or other communication units.

Communicating care management system 412 may be required to employ a Short Message Service (SMS) gateway 433 or similar facility to initiate communications with communication unit 418 according to a schedule determined by decision support system 434 or another component of communicating care management system 412. When a scheduled time arrives, a WAP Push message 431 may be sent (alternatively a SMS message may be sent) via SMS gateway 433 and network 414 to communication unit 418 to alert a patient using communication unit 418 to take a specified medication or to perform a specified test (e.g., blood sugar test). The user may be instructed by the WAP Push message to open a browser at communication unit 418 to enable a data session (e.g., a General Packet Radio Service (GPRS) data session) in order to download a medical script from communicating care management system 412.

A medical script may be an interactive script (also may be referred to as a protocol or guideline) that defines an interaction with a patient. The interaction may, by way of example and not by way of limitation, remind the patient to take medication or to perform a test such as measuring glucose, weight, blood pressure or another parameter. A script may ask questions of a patient, may provide a patient with information or may perform other alerting or inquiring actions. A patient may also initiate communications to pose a question, for example.

Using a medical script presented according to a schedule originating from communicating care management system 412 and conveyed using a WAP browser or other initiating communication protocol, test readings or other information may be obtained from a patient via a browser 415 associated with communicating unit 418 and stored in a patient health record 438. Intervention may be coordinated with a care giver 316_{y} (FIG. 8) depending upon the test results or other information received. The test results or other information may be manually entered into communication unit 418 by a user for transfer to communicating care management system 412, as indicated at 417.

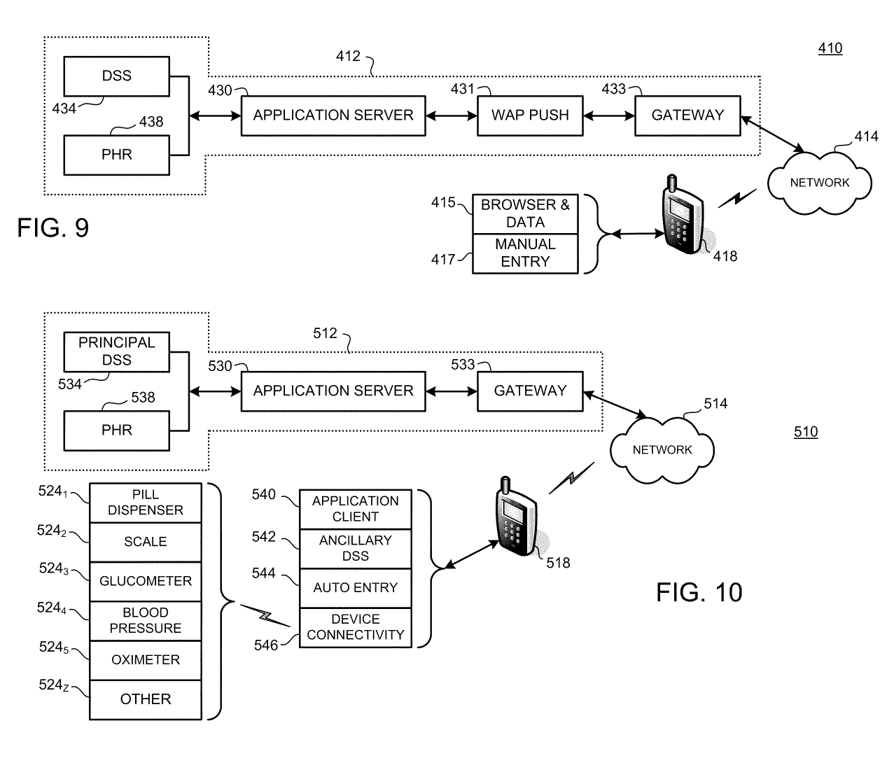

FIG. 10 is a top-level schematic diagram of the system illustrated in FIG. 8. In FIG. 10, a remote health management system 510 includes a communicating care management unit 512 and at least one communication network 514. Communicating care management system 512 may include a principal decision support unit 534, a patient health record database 538 and an application server 530, substantially as previously described herein. Principal decision support unit 534 may operate in cooperation with an ancillary decision support system 542, as will be described below. Communicating care management system 512 may communicate with network 514 via a gateway 533, as may be understood by one skilled in the art of communications. Gateway 533 may be embodied in a SMS gateway, for example. Communication unit 518 is illustrated in FIG. 10 as a wireless communication unit. However, the present invention may operate equally well with other communication units such as, by way of example and not by way of limitation, land line phone units, VoIP (Voice Over Internet Protocol) phone units, communicating computer units, smart phones, personal digital assistant (PDA) units or other communication units.

Communication unit 518 may be configured to effect wireless connectivity (indicated at 546) with medical equipment such as, by way of example and not by way of limitation, a pill dispenser unit 524₁, a scale 524₂, a glucometer 524₃, a blood pressure unit 524₄, an oximeter 524₅ and other medical monitoring or measuring equipment 524_{z}. The indicator “z” is employed to signify that there can be any number of medical equipment units in remote health management system 510. The inclusion of six medical equipment units 524₁, 524₂, 524₃, 524₄, 524₅, 524_{z} in FIG. 10 is illustrative only and does not constitute any limitation regarding the number of medical equipment units that may be included in the remote health management system of the present invention. Wireless connectivity between communication unit 518 and medical equipment units 524_{z} may be established using Bluetooth wireless interface or another wireless interface application.

Communication unit 518 may include or be coupled with an application client 540 and an ancillary decision support system 542. Application client 540 and ancillary decision support system 542 may operate to accommodate automatic entry (or manual entry) of parameters from medical equipment units 524_{z}. Preferably, once a reading is entered into one or both of application client 540 and ancillary decision support system 542 the data is time stamped and ancillary decision support system 542 evaluates whether the data is within certain predetermined parameters. By way of example and not by way of limitation, ancillary decision support system 542 may determine whether recently entered data was received within a predetermined time frame. If the recently entered data is within predetermined parameters or parametric values (or satisfies other parametric values), the recently entered data may be provided to communication unit 518 and communication unit 518 may forward the recently entered data to communicating care management system 512 for treatment according to protocols established in application server 430 or principal decision support system 434. Communicating care management system 512 may acknowledge the receipt of the recently entered data via network 514.

If the recently entered data is not within predetermined parameters, ancillary decision support system 542 may start an appropriate medical script asking a user of communication unit 518 to conduct the relevant test or take the relevant medication associated with the recently entered data. The medical script may proceed from an indication that the user has taken the medication or from an indication of a medical test. The medical script may end, by way of example and not by way of limitation, with an updating of patient health record database 538. An important advantage of using a disconnected mode of operation wherein medical decisions may be made or medical scripts may be presented to a user at remote communication unit 518 as determined by application client 540 or ancillary decision support system 542 or a combination of application client 540 and ancillary decision support system 542 may be a reduction of the amount of communications traffic between communicating care management system 512 and remote communication unit 518. No WAP Push message (or SMS message) is required from communicating care management system 512 to remote communication unit 518 to initiate conducting a test or reading. Certain interim communication messages between communicating care management system 512 and remote communication unit 518 may be foregone because decisions may be made and actions may be taken by application client 540 or ancillary decision support system 542 without direction from or reporting to communicating care management system 512.

Device connectivity unit 546 may be energized continually in order to provide continuous monitoring of medical equipment units 524_{z}. In order to conserve battery power in remote communications unit 518, one may arrange for device connectivity unit 546 to periodically poll medical equipment units 524_{z}.

One skilled in the art of remote health care management will understand that remote health management systems 410, 510 may be embodied in a single remote health management system serving a plurality of remote communication units (see, for example, FIG. 1). In such a combined arrangement, some remote communication units may be configured similarly to remote communication unit 418, requiring manual entry of data from medical equipment units and requiring WAP Push messages (or another type of message) to initiate or continue an event. In such a combined arrangement, other remote communication units may be configured for effecting a disconnected mode of operation that accommodates either manual or automatic entry of data obtained from medical equipment units, and can operate in a disconnected mode presenting medical scripts or carrying out other steps substantially independently of an associated communicating care management system.

In such a combined arrangement it would be advantageous to update medical scripts for use by each of a decision support system (e.g., decision support system 34, 434; FIGS. 1 and 9), a principal decision support system (e.g., principal decision support system 534; FIG. 10) and an ancillary decision support system (e.g., ancillary decision support system 542; FIG. 10) substantially simultaneously.

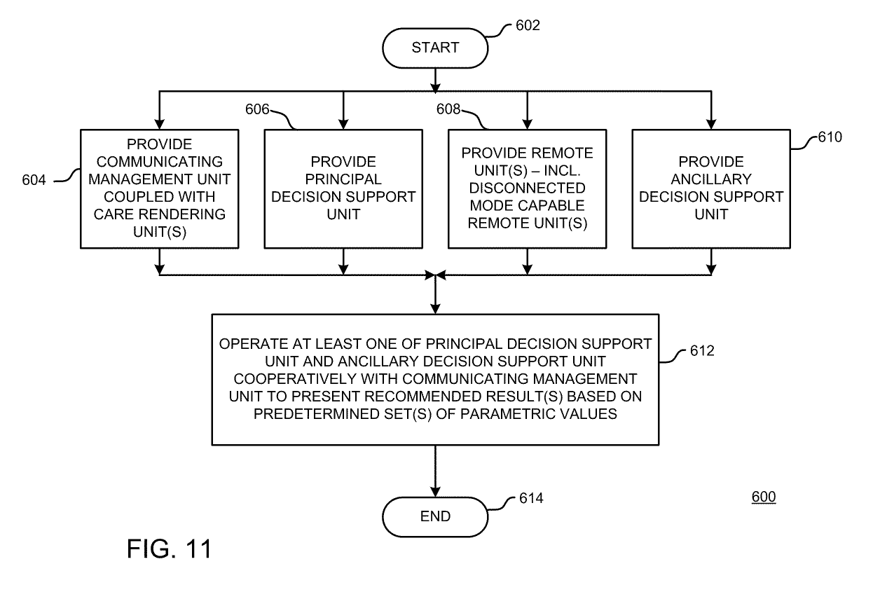

FIG. 11 is a flow chart illustrating the method for improved remote health management of the present invention. In FIG. 11, a method 600 for remote care management begins at a START locus 602.

Method 600 continues with, in no particular order: (1) providing a communicating management unit coupled with at least one care rendering unit, as indicated by a block 604; (2) providing a principal decision support unit coupled with the communicating management unit, as indicated by a block 606; (3) providing at least one remote unit coupled with the communicating management unit; the at least one remote unit including at least one disconnected mode capable remote unit, as indicated by a block 608; and (4) providing an ancillary decision support unit coupled with the at least one disconnected mode capable remote unit, as indicated by a block 610.

Method 600 continues with operating at least one of the principal decision support unit and the ancillary decision support unit cooperatively with the communicating management unit to present at least one recommended result based upon at least one predetermined set of parametric values to effect remote health management, as indicated by a block 612. Method 600 terminates at an END locus 614.

It is to be understood that, while the detailed drawings and specific examples given describe preferred embodiments of the invention, they are for the purpose of illustration only, that the apparatus and method of the invention are not limited to the precise details and conditions disclosed and that various changes may be made therein without departing from the spirit of the invention which is defined by the following claims:

We claim:

1. A system for effecting collaborative remote health care with a plurality of patients by a plurality of care rendering units; the system comprising:
(a) a communicating care management unit coupled with at least one care rendering unit of said plurality of care rendering units; said communicating care management unit including a principal decision support unit configured for formulating inquiries to a respective patient of said plurality of patients regarding prescribed actions originating from a respective care rendering unit of said plurality of care rendering units; and
(b) at least one remote unit communicatingly coupled with said communicating care management unit; said at least one remote unit including at least one disconnected mode capable remote unit;
said at least one disconnected mode capable remote unit including an ancillary decision support unit configured for formulating and presenting selected said inquiries when extant conditions associated with said ancillary decision support unit are within first predetermined limits; said principal decision support unit presenting said inquiries when said extant conditions are not within said first predetermined limits.

2. A system for effecting collaborative remote health care with a plurality of patients by a plurality of care rendering units as recited in claim 1 wherein the system further comprises a patient health record database, and wherein said ancillary decision support unit communicates information to said patient health record database when said extant conditions are within second predetermined limits.

3. A system for effecting collaborative remote health care with a plurality of patients by a plurality of care rendering units as recited in claim 1 wherein said at least one disconnected mode capable remote unit determines said selected inquiries based at least in part on at least one parametric value.

4. A system for effecting collaborative remote health care with a plurality of patients by a plurality of care rendering units as recited in claim 3 wherein said at least one parametric value is entered manually into said at least one disconnected mode capable remote unit by a user.

5. A system for effecting collaborative remote health care with a plurality of patients by a plurality of care rendering units as recited in claim 3 wherein the system further comprises at least one event monitoring unit wirelessly coupled with said at least one disconnected mode capable remote unit, and wherein said at least one parametric value is entered automatically by said at least one event monitoring unit into said at least one disconnected mode capable remote unit.

6. A system for effecting collaborative remote health care with a plurality of patients by a plurality of care rendering units as recited in claim 2 wherein said at least one disconnected mode capable remote unit determines said selected inquiries based at least in part on at least one parametric value.

7. A system for effecting collaborative remote health care with a plurality of patients by a plurality of care rendering units as recited in claim 3 wherein said at least one parametric value is entered manually into said at least one disconnected mode capable remote unit by a user.

8. A system for effecting collaborative remote health care with a plurality of patients by a plurality of care rendering units as recited in claim 3 wherein the system further comprises at least one event monitoring unit wirelessly coupled with said at least one disconnected mode capable remote unit, and wherein said at least one parametric value is entered automatically by said at least one event monitoring unit to said at least one disconnected mode capable remote unit.

9. A system for remote care management comprising:
(a) a communicating management unit coupled with at least one care rendering unit; said communicating management unit including a principal decision support unit; and
(b) at least one remote unit communicatingly coupled with said communicating management unit; said at least one remote unit including at least one disconnected mode capable remote unit; said at least one disconnected mode capable remote unit including an ancillary decision support unit;
at least one of said principal decision support unit and said ancillary decision support unit cooperating with said communicating management unit to present at least one recommended result based upon at least one predetermined set of parametric values to effect said remote health management.

10. A system for remote care management as recited in claim 9 wherein the system further comprises a patient health record database, and wherein said ancillary decision support unit communicates information to said patient health record database when said parametric values are within-limit values being within predetermined limits.

11. A system for remote care management as recited in claim 9 wherein said at least one disconnected mode capable remote unit presents said at least one recommended result based at least in part on said at least one predetermined set of parametric values being within predetermined limits.

12. A system for remote care management as recited in claim 11 wherein said parametric values are entered manually into said at least one disconnected mode capable remote unit by a user.

13. A system for remote care management as recited in claim 11 wherein the system further comprises at least one event monitoring unit wirelessly coupled with said at least one disconnected mode capable remote unit, and wherein said parametric values are entered automatically by said at least one event monitoring unit into said at least one disconnected mode capable remote unit.

14. A system for remote care management as recited in claim 10 wherein said at least one disconnected mode capable remote unit presents said at least one recommended result based at least in part on said at least one predetermined set of parametric values being within predetermined limits.

15. A system for remote care management as recited in claim 14 wherein said parametric values are entered manually into said at least one disconnected mode capable remote unit by a user.

16. A system for remote care management as recited in claim 14 wherein the system further comprises at least one event monitoring unit wirelessly coupled with said at least one disconnected mode capable remote unit, and wherein said parametric values are entered automatically by said at least one event monitoring unit to said at least one disconnected mode capable remote unit.

17. A method for remote care management comprising:
(a) in no particular order:
(1) providing a communicating management unit coupled with at least one care rendering unit;
(2) providing a principal decision support unit coupled with said communicating management unit;
(3) providing at least one remote unit coupled with said communicating management unit; said at least one remote unit including at least one disconnected mode capable remote unit; and
(4) providing an ancillary decision support unit coupled with said at least one disconnected mode capable remote unit; and
(b) operating at least one of said principal decision support unit and said ancillary decision support unit cooperatively with said communicating management unit to present at least one recommended result based upon at least one predetermined set of parametric values to effect said remote health management.

18. A method for remote care management as recited in claim 17 wherein said communicating management unit includes a patient health record database, and wherein said ancillary decision support unit communicates information to said patient health record database when said parametric values are within-limit values being within predetermined limits.

19. A method for remote care management as recited in claim 17 wherein said at least one disconnected mode capable remote unit presents said at least one recommended result based at least in part on said at least one predetermined set of parametric values being within predetermined limits.

20. A method for remote care management as recited in claim 17 wherein said at least one disconnected mode capable remote unit is wirelessly coupled with at least one event monitoring unit, and wherein said parametric values are entered automatically by said at least one event monitoring unit into said at least one disconnected mode capable remote unit.
